(19) United States
(12) Patent Application Publication
(10) Pub. No.: US 2008/0279713 A1
(43) Pub. Date: Nov. 13, 2008

(54) HIGH STRENGTH WEATHERING STEEL AND METHOD FOR PRODUCING THE SAME

(75) Inventors: Xinping MAO, Guangzhou (CN); Zhenyuan LIN, Guangzhou (CN); Kexin LI, Guangzhou (CN); Jixiang GAO, Guangzhou (CN); Yijun LIU, Guangzhou (CN); Qilin CHEN, Guangzhou (CN); Jinsong XIE, Guangzhou (CN)

Correspondence Address: MATTHIAS SCHOLL, 14781 MEMORIAL DRIVE, SUITE 1319, HOUSTON, TX, 77079, US

(73) Assignee: GUANGZHOU ZHUJIANG STEEL CO., LTD, Guangzhou (CN)

(21) Appl. No.: 12/177,982

(22) Filed: Jul. 23, 2008

Related U.S. Application Data
(63) Continuation-in-part of application No. PCT/CN2006/000034, filed on Dec. 18, 2006.

(30) Foreign Application Priority Data
Nov. 10, 2006 (CN) 200610123458.1

(51) Int. Cl. C22C 38/42; C21D 6/00

(52) U.S. Cl. 420/91; 148/541

(57) ABSTRACT

A weathering steel consisting essentially of C in the range of from 0.03 to 0.07 percent by weight; Si in the range of from 0.15 to 0.29 percent by weight; Mn in the range of from 1.21 to 1.5 percent by weight; P in the range of from 0.006 to 0.04 percent by weight; S in the range of from 0.001 to 0.01 percent by weight; Cu in the range of from 0.2 to 0.5 percent by weight; Cr in the range of from 0.3 to 0.7 percent by weight; Ni in the range of from 0.15 to 0.35 percent by weight; Ti in the range of from 0.08 to 0.14 percent by weight; and the balance is essentially iron; and methods for producing the same.

### CROSS-REFERENCE TO RELATED APPLICATIONS

This application is a continuation-in-part of International Patent Application No. PCT/CN2006/00003454, with an international filing date of Dec. 18, 2006, which is based on Chinese Patent Application No. 200610123458.1, filed Nov. 10, 2006. The contents of these specifications are incorporated herein by reference.

### BACKGROUND OF THE INVENTION

1. Field of the Invention

The invention relates to steel and, more particularly to high-strength weathering steel and to a method for producing the same.

2. Description of the Related Art

Nowadays, high strength weathering steels are widely used in transportation and manufacturing. A 700 MPa high strength weathering steel is one of the strongest available.

The conventional production process of the 700 MPa high strength weathering steel employs composite microalloy technology, which has complex control procedures, low product rate, and high cost.

Chinese Pat. No. CN1785543A discloses a method for producing high strength weathering steels using a simple Ti microalloy technology. However, the method is incapable of producing weathering steels having yield strength greater than 700 MPa. Accordingly, much opportunity for improvement remains.

### SUMMARY OF THE INVENTION

In view of the above-described problems, it is one objective of the invention to provide high strength weathering steel and a method for producing the same using a simple Ti microalloy technology, the method being capable of producing a weathering steel having a yield strength greater than 700 MPa.

To achieve the above objectives, in accordance with one embodiment of the invention, provided is a weathering steel consisting essentially of the following weigh composition: carbon (C) is present in the range of from 0.03 to 0.07 percent by weight; silicon (Si) is present in the range of from 0.15 to 0.29 percent by weight; manganese (Mn) is present in the range of from 1.21 to 1.5 percent by weight; phosphorus (P) is present in the range of from 0.006 to 0.04 percent by weight; sulfur (S) is in the range of from 0.001 to 0.01 percent by weight; copper (Cu) is present in the range of from 0.2 to 0.5 percent by weight; chromium (Cr) is present in the range of from 0.3 to 0.7 percent by weight; nickel (Ni) is present in the range of from 0.15 to 0.35 percent by weight; titanium (Ti) is present in the range of from 0.08 to 0.14 percent by weight; and the rest is essentially iron (Fe). Steel composition is assessed in the steel in its molten state or after cooling.

In accordance with another embodiment of the invention, provided is a method for producing high strength weathering steel of the chemical composition described above, comprising employing a thin slab casting and rolling technology, the technology comprising smelting, refining, thin slab continuous casting, soaking, hot continuous rolling, laminar cooling and coiling; wherein the charging temperature is between 950 and 1050° C., the tapping temperature is between 1100 and 1150° C., the finishing temperature is between 870 and 920° C., and the coiling temperature is between 550 and 650° C.

In certain classes of these embodiments, the high strength weathering steel does not consist of niobium (Nb), molybdenum (Mo), and/or Vanadium (V).

In certain classes of these embodiments, Nb, Mo, V and/or materials enriched in Nb, Mo, and/or V are not added during the production process.

In certain classes of these embodiments, the steel has a yield strength of at least 700 MPa, at least 710 MPa, at least 720 MPa, at least 730 MPa, at least 740 MPa, at least 750 MPa, at least 760 MPa, at least 770 MPa, at least 780 MPa, at least 790 MPa, at least 800 MPa, at least 810 MPa, at least 820 MPa, at least 830 MPa, at least 840 MPa, at least 850 MPa, at least 860 MPa, at least 870 MPa, at least 880 MPa, at least 890 MPa, at least 900 MPa.

Advantages of the invention include:
1) By using a simple Ti microalloy technology, expensive metal elements such as Mo, Nb, V and so on are not needed. By decreasing S content in liquid steel, preventing Ti from being mixed with S, and controlling rolling and coiling temperature, a TiC precipitate is formed by fully mixing Ti with C during a cooling and a coiling process. Thus, the yield strength is improved by precipitation.
2) By adding Mn and Ti, needle-like ferrite is formed during the cooling process of steel strip and thus, microstructure of steel is composed of large amount of ferrite and small amount of needle-like ferrite. As a result, high yield strength and good toughness and formability is obtained.
3) By restricting P to a range within 0.04%, tiny crack is prevented from being generated within a casting billet, and good formability is assured.
4) By restricting Si to the range of between 0.15-0.29%, a compromise between yield strength and formability is realized.
5) By using thin slab casting and rolling technology, fluctuation in the performance of Ti microalloy steels is controlled, and the yield strength of steel is stabilized above 700 MPa.

### DETAILED DESCRIPTION OF THE INVENTION

### Example 1

In a first example, the method for producing 700 MPa high strength weathering steel comprises: (a) smelting in a 150 t ultra-high power electric furnace, (b) refining in a 150 t ladle furnace, (c) continuous casting into a 60 mm thin slab, (d) soaking, (e) descaling using high pressure water, (f) hot continuous rolling through 6 stands, (g) laminar cooling, and (h) coiling.

The steel comprises the following chemical elements by weight: C is 0.03 percent by weight; Si is 0.29 percent by weight; Mn is 1.5 percent by weight; P is 0.006 percent by weight; S is 0.001 percent by weight; Cu is 0.5 percent by weight; Cr is 0.3 percent by weight; Ni is 0.35 percent by weight; Ti is 0.08 percent by weight; and N is 0.007 percent by weight.

The process parameters are as follows: the charging temperature of the casting billet is 950° C., the tapping temperature thereof is 1100° C., the finishing temperature thereof is 870° C., and the coiling temperature thereof is 550° C.

Mechanical properties of a steel sheet according to the first embodiment are shown in Table 1.

TABLE 1

| Thickness of steel | Rel | Rm | A₅ | Wide cold bending |
|---|---|---|---|---|
| sheet (mm) | (Mpa) | (Mpa) | (Mpa) | B = 35 mm, d = a, 180° |
| 6 | 725 | 780 | 26 | Qualified |
| 5 | 730 | 785 | 25 | Qualified |
| 4 | 750 | 790 | 25 | Qualified |
| 3.5 | 765 | 815 | 23 | Qualified |
| 3.2 | 755 | 810 | 23 | Qualified |
| 3 | 760 | 815 | 22 | Qualified |
| 2.5 | 780 | 825 | 22 | Qualified |

### Example 2

In a second example, a method for producing 700 MPa high strength weathering steel comprises: (a) smelting in a 150 t ultra-high power electric furnace, (b) refining in a 150 t ladle furnace, (c) continuous casting into a 50 mm thin slab, (d) soaking, (e) descaling using high pressure water, (f) hot continuous rolling through 6 stands, (g) laminar cooling, and (h) coiling.

The steel comprises the following chemical elements by weight: C is 0.07 percent by weight; Si is 0.15 percent by weight; Mn is 1.21 percent by weight; P is 0.04 percent by weight; S is 0.01 percent by weight; Cu is 0.2 percent by weight; Cr is 0.7 percent by weight; Ni is 0.15 percent by weight; Ti is 0.14 percent by weight; and N is 0.005 percent by weight.

The process parameters are as follows: the charging temperature of the casting billet is 1050° C., the tapping temperature thereof is 1150° C., the finishing temperature thereof is 920° C., and the coiling temperature thereof is 6° C.

Mechanical properties of a steel sheet according to the second embodiment are shown in Table 2.

TABLE 2

| | | | | Wide cold |
|---|---|---|---|---|
| Thickness of | | | | bending |
| steel sheet | Rel | Rm | A₅ | B = 35 mm, d = a, |
| (mm) | (Mpa) | (Mpa) | (Mpa) | 180° |
| 6 | 715 | 775 | 25 | Qualified |
| 5 | 745 | 800 | 25 | Qualified |
| 4 | 750 | 805 | 24 | Qualified |
| 3.5 | 745 | 795 | 24 | Qualified |
| 3.2 | 765 | 820 | 24 | Qualified |
| 3 | 775 | 805 | 23 | Qualified |
| 2.5 | 790 | 810 | 22 | Qualified |

### Example 3

In a third example, a method for producing 700 MPa high strength weathering steels comprises: (a) smelting in a 150 t ultra-high electric furnace, (b) refining in a 150 t ladle furnace, (c) continuous casting into a 55 mm thin slab, (d) soaking, (e) descaling using high pressure water, (f) hot continuous rolling through 6 stands, (g) laminar cooling, and (h) coiling.

The steel comprises the following chemical elements by weight: C is 0.05 percent by weight; Si is 0.23 percent by weight; Mn is 1.4 percent by weight; P is 0.027 percent by weight; S is 0.005 percent by weight; Cu is 0.29 percent by weight; Cr is 0.058 percent by weight; Ni is 0.22 percent by weight; Ti is 0.12 percent by weight; and N is 0.006 percent by weight.

The process parameters are as follows: the charging temperature of a casting billet is 1000° C., the tapping temperature thereof is 1134° C., the finishing temperature thereof is 903° C., and the coiling temperature thereof is 605° C.

Mechanical properties of a steel sheet according to the third embodiment are shown in Table 3.

TABLE 3

| | | | | Wide cold |
|---|---|---|---|---|
| Thickness of | | | | bending |
| steel sheet | Rel | Rm | A₅ | B = 35 mm, d = a, |
| (mm) | (Mpa) | (Mpa) | (Mpa) | 180° |
| 6 | 710 | 805 | 23 | Qualified |
| 5 | 740 | 810 | 22 | Qualified |
| 4 | 770 | 810 | 22 | Qualified |
| 3.5 | 765 | 810 | 22 | Qualified |
| 3.2 | 755 | 810 | 22 | Qualified |
| 3 | 780 | 820 | 21 | Qualified |
| 2.5 | 780 | 835 | 21 | Qualified |

This invention is not to be limited to the specific embodiments disclosed herein and modifications for various applications and other embodiments are intended to be included within the scope of the appended claims. While this invention has been described in connection with particular examples thereof, the true scope of the invention should not be so limited since other modifications will become apparent to the skilled practitioner upon a study of the drawings, specification, and following claims.

All publications and patent applications mentioned in this specification are indicative of the level of skill of those skilled in the art to which this invention pertains. All publications and patent applications mentioned in this specification are herein incorporated by reference to the same extent as if each individual publication or patent application mentioned in this specification was specifically and individually indicated to be incorporated by reference.

What is claimed is:

1. A weathering steel consisting essentially of:
C in the range of from 0.03 to 0.07 percent by weight;
Si in the range of from 0.15 to 0.29 percent by weight;
Mn in the range of from 1.21 to 1.5 percent by weight;
P in the range of from 0.006 to 0.04 percent by weight;
S in the range of from 0.001 to 0.01 percent by weight;
Cu in the range of from 0.2 to 0.5 percent by weight;
Cr in the range of from 0.3 to 0.7 percent by weight;
Ni in the range of from 0.15 to 0.35 percent by weight;
Ti in the range of from 0.08 to 0.14 percent by weight; and
the balance is essentially iron.

2. The steel of claim 1, produced by a process comprising the steps of:
(a) smelting at a charging temperature via a furnace or a converter to produce molten steel,
(b) refining said molten steel at a tapping temperature,
(c) thin slab continuous casting of a casting billet,
(d) soaking of said casting billet,
(e) hot continuous rolling of said casting billet at a finishing temperature,
(f) laminar cooling of said casting billet, and
(g) coiling of said casting billet at a coiling temperature,
wherein
the charging temperature is 950-1050° C.,
the tapping temperature is 1100-1150° C.,
the finishing temperature is 870-920° C., and
the coiling temperature is 550-650° C.

3. The steel of claim 1, said steel not consisting of Nb, Mo, or V.

4. The steel of claim 1 having a yield strength of at least 700 MPa.

5. The steel of claim 1 having a yield strength of at least 750 MPa.

6. The steel of claim 1 having a yield strength of at least 780 MPa.

7. The steel of claim 1 having a yield strength of at least 800 MPa.

8. A method for producing high yield strength weathering steel comprising:
(a) smelting at a charging temperature via a furnace or a converter to produce molten steel,
(b) refining said molten steel at a tapping temperature,
(c) thin slab continuous casting of a casting billet,
(d) soaking of said casting billet,
(e) hot continuous rolling of said casting billet at a finishing temperature,
(f) laminar cooling of said casting billet, and
(g) coiling of said casting billet at a coiling temperature,
wherein
the charging temperature is between 950 and 1050° C.,
the tapping temperature is between 1100 and 1150° C.,
the finishing temperature is between 870 and 920° C., and
the coiling temperature is between 550 and 650° C.
